(19) United States
(12) Patent Application Publication
(10) Pub. No.: US 2005/0159855 A1
(43) Pub. Date: Jul. 21, 2005

(54) Shape change detection apparatus

(75) Inventors: Makiko Sugiura, Hekinan-shi (JP); Inao Toyoda, Anjo-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/036,093

(22) Filed: Jan. 18, 2005

(30) Foreign Application Priority Data
Jan. 21, 2004 (JP) 2004-13065

(51) Int. Cl. G06F 17/00

(52) U.S. Cl. 701/1; 702/155

(57) ABSTRACT

A control circuit sends a drive signal to a transmitting section. The transmitting section generates ultrasonic waves based on the drive signal. The ultrasonic waves are transmitted toward a side surface portion Ta of a tire T. A receiving section receives reflection sounds as ultrasonic waves reflected from the side surface portion Ta of the tire T. The receiving section sends a detection signal to the control circuit. Based on both the drive signal and the detection signal, the control circuit detects a shape change (i.e. degree of deformation) of the side surface portion Ta of the tire T. Then, the control circuit 14 calculates the stress (particularly, the lateral stress) acting from the road surface P to the wheel W based on the detection result of the shape change. Then, the control circuit produces a data signal D representing the calculated stress.

### CROSS-REFERENCE TO RELATED APPLICATION

This application is based upon and claims the benefit of priority from earlier Japanese Patent Application No. 2004-13065 filed on Jan. 21, 2004 so that the description of which is incorporated herein by reference.

### BACKGROUND OF THE INVENTION

The present invention relates to a shape change detection apparatus, and more particularly to an apparatus for detecting a shape change of a particular detection object (e.g. a wheel of a vehicle or the like) based on the reflection of ultrasonic waves.

When a driver steers the vehicle to avoid an obstacle on the road, or when the vehicle is traveling on a slippery curved road, the vehicle (i.e. the automotive vehicle) may be subjected to a lateral slip. The lateral slip of the vehicle can be suppressed by adequately controlling both the engine output and the braking force applied to respective wheels. This kind of control is preferable to secure the stability of the vehicle and realize the pre-crush safety (i.e. collision prediction and damage reduction). In this respect, various techniques relating to the stability of the vehicle, generally known as VDC (Vehicle Dynamics Control), VSC (Vehicle Stability Control) or the like, have been recently proposed.

According to the vehicle stability control techniques, the lateral slip of the vehicle is judged based on the stress acting from the road surface to a wheel. The lateral slip of the vehicle can be accurately judged only when the stress (especially, the lateral stress) acting from the road surface to the wheel is accurately detected.

There is a conventional technique for detecting the stress acting from the road surface to the wheel, according to which an encoder is attached to the tire surface of a wheel. The encoder has permanent magnets arranged to have alternate N and S polarities. Two pickup sensors are attached to a chassis of the vehicle to measure the magnetic field of the encoder. The pickup sensors can detect the stress acting from the road surface to the wheel by detecting the deformation of the tire surface based on the measured magnetic field (for example, refer to the International Publication No. WO 01/019654).

However, the above-described conventional technique requires preparation of a special tire equipped with the encoder including the permanent magnets attached on the tire surface. In other words, this conventional technique is not applicable to the vehicle using ordinary tires.

### SUMMARY OF THE INVENTION

In view of the above-described problems, the present invention has an object to provide a shape change detection apparatus which is capable of surely detecting a shape change of a particular detection object.

In order to accomplish the above and other related objects, the present invention provides a first shape change detection apparatus including a transmitting means, a receiving means, and a shape change detecting means. The transmitting means of the first shape change detection apparatus transmits a sensing medium (such as ultrasonic waves, millimeter waves, and infrared rays) to a detection object. The receiving means receives a reflected sensing medium from the detection object after the sensing medium is transmitted from the transmitting means. The shape change detecting means detects a shape change of the detection object based on the sensing medium transmitted from the transmitting means and the sensing medium received by the receiving means. The receiving means of the first shape change detection apparatus of this invention includes a plurality of receiving sections each having the capability of receiving the reflected sensing medium. And, the receiving sections are arrayed in a predetermined pattern (i.e. in a predetermined matrix or two-dimensional pattern).

Furthermore, in order to accomplish the above and other related objects, the present invention provides a second shape change detection apparatus including a transmitting means, a receiving means, and a shape change detecting means. The transmitting means of the second shape change detection apparatus transmits ultrasonic waves to a predetermined portion of a wheel of a vehicle. The receiving means receives reflection sounds as ultrasonic waves reflected from the wheel after the ultrasonic waves are transmitted from the transmitting means. The shape change detecting means detects a shape change of the predetermined portion of the wheel based on the ultrasonic waves transmitted from the transmitting means and the ultrasonic waves received by the receiving means. The receiving means of the second shape change detection apparatus of this invention includes a plurality of receiving sections each having the capability of receiving ultrasonic waves. And, the receiving sections are arrayed in a predetermined pattern (in a predetermined matrix or two-dimensional pattern).

According to a preferred embodiment of the present invention, the predetermined portion of the wheel is a side surface portion of the wheel located in the vicinity of the bottom of the wheel where the wheel contacts with a road surface.

According to another preferred embodiment of the present invention, the predetermined portion of the wheel is an outer circumferential surface of an axle connected to the wheel.

It is also preferable that the predetermined portion of the wheel is an arbitrary portion of a rim of the wheel.

It is also preferable that the second shape change detection apparatus of this invention further includes stress detecting means for detecting the stress acting from a road surface to the wheel based on the shape change of the predetermined portion of the wheel detected by the shape change detecting means.

It is preferable that the plurality of receiving sections arranging the receiving means and the transmitting means are mounted together on a single substrate.

According to the first shape change detection apparatus of this invention, a plurality of receiving sections each having the capability of receiving the reflected sensing medium are arrayed in a predetermined pattern so as to arrange the receiving means. The receiving means receives the reflected sensing medium from the detection object after the sensing medium is transmitted from the transmitting means. Thus, the first shape change detection apparatus of this invention can detect a three-dimensional shape change of the detection object.

The number of receiving sections arranging the receiving means corresponds to the resolution of a shape change detection value. A higher resolution can be obtained by increasing the total number of the receiving sections. Furthermore, the spatial intervals of the receiving sections should be set to the distance shorter than the wavelength of the sensing medium transmitted from the transmitting means. The spatial intervals of respective receiving sections correspond to the resolution of a shape change detection value. Therefore, regarding the total number and spatial intervals of respective receiving sections, it is preferable to experimentally obtain optimum values through a cut and try testing considering the required resolution.

Like the above-described first shape change detection apparatus, the second shape change detection apparatus of this invention can detect a three-dimensional shape change of a predetermined portion of the vehicle wheel. Providing the ultrasonic transmitting and receiving means enables the shape change detecting means to accurately detect a shape change occurring at a predetermined portion of the wheel without adding any modification to the wheel. The second shape change detection apparatus is therefore applicable to the ordinary tires and is realizable at a low cost.

According to a preferred embodiment of the present invention, the predetermined portion of the wheel is a side surface portion of the wheel located in the vicinity of the wheel where the wheel contacts with the road surface. Alternatively, the predetermined portion of the wheel is an outer circumferential surface of an axle connected to the wheel. Furthermore, the predetermined portion of the wheel is a predetermined portion of the wheel or an arbitrary portion of a rim of the wheel.

According to a preferred embodiment of the present invention, the stress detecting means detects the stress acting from the road surface to the wheel based on a shape change occurring at the predetermined portion of the wheel. It is preferable to control both the engine output and the braking force of the vehicle based on the stress (especially lateral stress) acting from the road surface to the wheel. Such a cooperative control is effective in suppressing a lateral slip of the vehicle which may occur when a driver steers the vehicle to avoid an obstacle on the road, or when the vehicle is traveling on a slippery curved road. Thus, it becomes possible to secure the stability of the vehicle. Both the collision precognition and the damage reduction can be realized.

According to a preferred embodiment of the present invention, the plurality of receiving sections arranging the receiving means and the transmitting means are integrated on the single (i.e. same) substrate. This is effective in downsizing the receiving means and the transmitting means. The receiving means and the transmitting means can be easily installed or assembled to the vehicle.

The characteristic features of the present invention will be readily understood with reference to preferred embodiments of the present invention which are explained hereinafter.

For example, the “detection object” of this invention corresponds to a side surface portion Ta of a tire T located in the vicinity of the bottom of this tire T where the tire T contacts with a road surface P, an outer circumferential surface of an axle S, or an appropriate portion of a rim R. Furthermore, the “transmitting means” and “receiving means” of this invention correspond to an ultrasonic sensor 12. Furthermore, the “shape change detecting means” and “stress detecting means” of this invention correspond to a control circuit 14.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a perspective view explaining a schematic arrangement of a tire shape change detection apparatus 10 in accordance with a first embodiment of the present invention;

FIG. 2 is a perspective view showing a schematic arrangement of an ultrasonic sensor 12 in accordance with the first embodiment of the present invention;

FIG. 3A is a cross-sectional view showing a schematic arrangement of a piezoelectric ultrasonic sensor 12 in accordance with the first embodiment of the present invention;

FIG. 3B is a cross-sectional view showing a schematic arrangement of a capacitive ultrasonic sensor 12 in accordance with the first embodiment of the present invention;

FIG. 4 is a perspective view explaining a schematic arrangement of a tire shape change detection apparatus 30 in accordance with a second embodiment of the present invention; and

FIG. 5 is a perspective view showing a schematic arrangement of another ultrasonic sensor 12 in accordance with the present invention.

### DESCRIPTION OF THE PREFERRED EMBODIMENTS

Hereinafter, preferred embodiments of the present invention will be explained with reference to attached drawings.

### First Embodiment

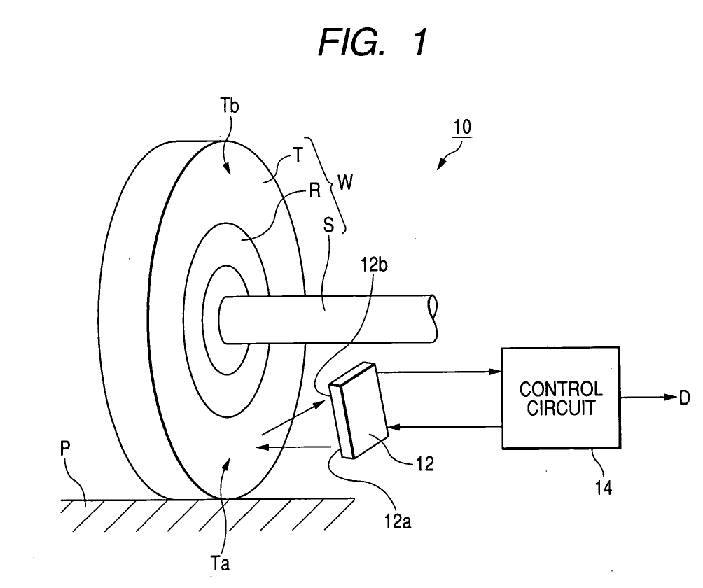

FIG. 1 is a perspective view explaining a schematic arrangement of a tire shape change detection apparatus 10 in accordance with a first embodiment of the present invention. The tire shape change detection apparatus 10 includes an ultrasonic sensor 12 and a control circuit 14.

A wheel W of a vehicle (i.e. automotive vehicle) consists of an axle (i.e. shaft) S, a rim R fixed to the axle S, and a tire T coupled around the rim R. The ultrasonic sensor 12 is securely attached or fixed to an appropriate portion of a chassis (not shown) of the vehicle.

The ultrasonic sensor 12 includes a transmitting section 12a and a receiving section 12b. The transmitting section 12a is capable of transmitting ultrasonic waves to a detection object, while the receiving section 12b is capable of receiving ultrasonic waves returning from the detection object. Both the transmitting section 12a and the receiving section 12b, in a condition that they are firmly attached to the vehicle body (chassis), face toward a side surface portion Ta of the tire T located in the vicinity of the bottom of the tire T where the tire T contacts with a road surface P.

The control circuit 14 produces a drive signal which is sent to the transmitting section 12a. In response to this drive signal, the transmitting section 12a generates ultrasonic waves which are emitted toward the side surface portion Ta of the tire T. The ultrasonic waves transmitted from the transmitting section 12a reflect at the side surface portion Ta of the tire T. The receiving section 12b receives reflection sounds as ultrasonic waves reflected from the side surface portion Ta of the tire T. The receiving section 12b generates a detection signal representing the reflected ultrasonic waves which is sent to the control circuit 14.

On the other hand, the control circuit 14 obtains a phase difference between the ultrasonic waves transmitted from the transmitting section 12a and the ultrasonic waves received by the receiving section 12b, based on the drive signal and the detection signal. Furthermore, the control circuit 14 detects a shape change (i.e. the degree of deformation) of the side surface portion Ta of the tire T based on the obtained phase difference. Then, the control circuit 14 calculates the stress (particularly, the lateral stress) acting from the road surface P to the wheel W based on the detection result of the shape change. Finally, the control circuit 14 produces a data signal D representing the calculated stress.

The data signal D produced from the control circuit 14 is sent to an engine control apparatus (not shown in the drawing) and also to a brake control apparatus (not shown in the drawing) of the vehicle. The engine control apparatus controls the engine output based on the received data signal D, while the brake control apparatus controls the braking force based on the received data signal D. These control apparatuses can perform a cooperative control for suppressing a lateral slip of the vehicle which may occur when a driver steers the vehicle to avoid an obstacle on the road, or when the vehicle is traveling on a slippery curved road. Thus, it becomes possible to secure the stability of the vehicle. The collision precognition and the damage reduction can be realized.

### Arrangement of Ultrasonic Sensor

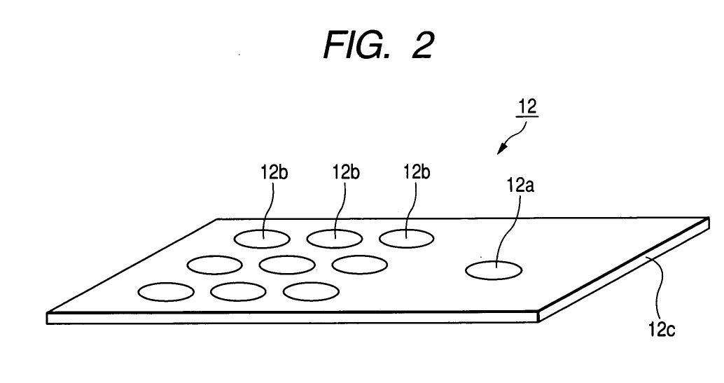

FIG. 2 is a perspective view showing a schematic arrangement of the ultrasonic sensor 12 in accordance with the first embodiment of the present invention. The ultrasonic sensor 12 includes a single transmitting section 12a and a plurality of (e.g. nine according to the example shown in FIG. 2) receiving sections 12b arrayed in a predetermined (i.e. matrix or two-dimensional) pattern on a single substrate 12c. The ultrasonic sensor 12 of this embodiment is a piezoelectric type or a capacitive type.

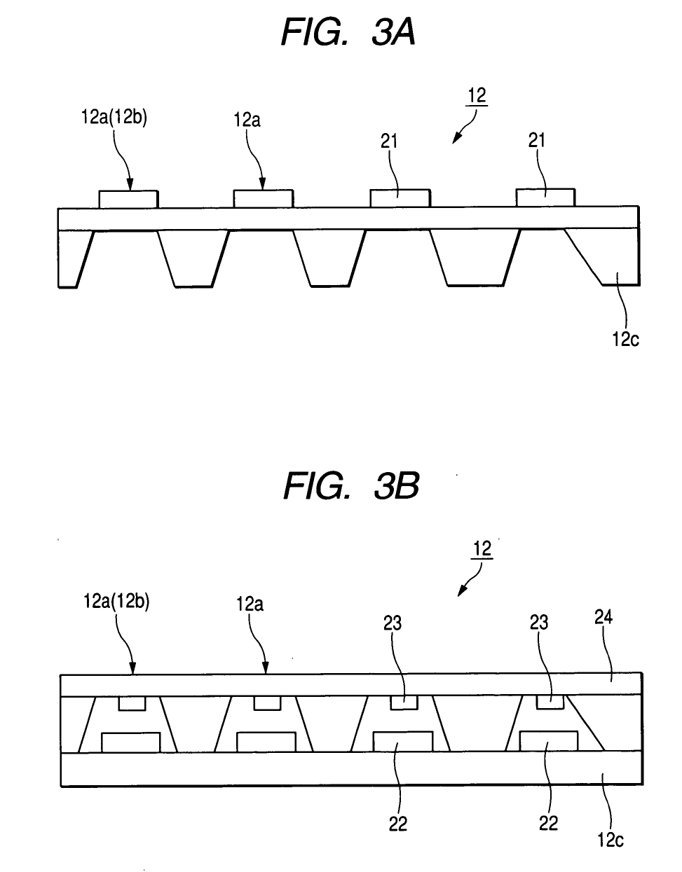

FIG. 3A is a cross-sectional view schematically showing a piezoelectric ultrasonic sensor 12. In the case of piezoelectric type, the ultrasonic sensor 12 includes a plurality of thin film portions 21 of ferroelectric (for example, PZT (lead zirconate titanate) thin film portions) formed and arranged on a SOI (Silicon On Insulator) substrate 12c. Each thin film portion 21 forms a transmitting section 12a or a receiving section 12b. According to the piezoelectric ultrasonic sensor 12, the transmitting section 12a causes the thin film portion 21 to oscillate and generate ultrasonic waves due to the piezoelectric effect in accordance with an input signal. The receiving section 12b generates an electric signal when the thin film portion 21 oscillates in response to received ultrasonic waves due to the piezoelectric effect.

FIG. 3B is a cross-sectional view schematically showing a capacitive ultrasonic sensor 12. The capacitive ultrasonic sensor 12 includes a plurality of stationary electrodes 22 formed on a silicon substrate 12c and a plurality of movable electrodes 23 formed on an oscillation film (i.e. diaphragm) 24. Each stationary electrode 22 is disposed in an opposed relationship with an associated movable electrode 22 with a predetermined gap. A pair of opposed electrodes 22 and 23 arranges the transmitting section 12a or the receiving section 12b. According to the γ-capacitive ultrasonic sensor 12, the transmitting section 12a causes an electrostatic attraction force between the paired electrodes 22 and 23 in accordance with the input signal. The oscillating film 24 oscillates and generates ultrasonic waves. The ultrasonic waves, generated from the transmitting section 12a and received by the receiving section 12b, can cause the oscillation film 24 of the receiving section 12b to oscillate. This induces a change in the capacitance between the paired electrodes 22 and 23. The control circuit 14 converts the change appearing in the capacitance between the paired electrodes 22 and 23 into an electric signal.

As apparent from the foregoing description, the first embodiment of the present invention provides a shape change detection apparatus including a transmitting means (i.e. ultrasonic sensor 12) for transmitting ultrasonic waves to a predetermined portion (i.e. side surface portion Ta) of a wheel of a vehicle. The shape change detection apparatus further includes a receiving means (i.e. ultrasonic sensor 12) for receiving reflection sounds as ultrasonic waves reflected from the wheel after the ultrasonic waves are transmitted from the transmitting means. The shape change detection apparatus further includes a shape change detecting means (i.e. control circuit 14) for detecting a shape change of the predetermined portion of the wheel based on the ultrasonic waves transmitted from the transmitting means and the ultrasonic waves received by the receiving means. Furthermore, the receiving means (i.e. ultrasonic sensor 12) includes a plurality of receiving sections 12b each having the capability of receiving ultrasonic waves, and these receiving sections 12b are arrayed in a predetermined pattern.

### Functions and Effects of the First Embodiment

The above-described first embodiment of the present invention has the following functions and effects.

(1) Both the transmitting section 12a and the receiving section 12b of the ultrasonic sensor 12 face the side surface portion Ta of the tire T located in the vicinity of the bottom of the tire T where the tire T contacts with the road surface P. The transmitting section 12a transmits ultrasonic waves toward the side surface portion Ta of the tire T. The control circuit 14 detects a shape change of the side surface portion Ta of the tire T, and calculates the stress acting from the road surface P to the wheel W based on the detection result of the shape change.

More specifically, the portion where the largest deformation appears in response to the stress (especially, the lateral stress) acting from the road surface P to the wheel W is the side surface portion Ta of the tire T located in the vicinity of the bottom of the tire T where the tire T contacts with the road surface P. The ultrasonic sensor 12 detects a shape change occurring at the side surface portion Ta of the tire T, thereby accurately detecting the stress acting from the road surface P to the wheel W.

It is possible to use the ultrasonic sensor 12 to detect a shape change of an upper side surface portion Tb of the tire T located in the vicinity of the top of the tire T (refer to FIG. 1). Even in this case, detecting the stress is possible. However, the upper side surface portion Tb of the tire T tends to cause a shape change due to vibrations of the tire T occurring in various vehicle traveling conditions. Therefore, the detection accuracy of the stress is lessened.

(2) Using the ultrasonic sensor 12 enables the control circuit 14 to accurately detect a shape change occurring at the side surface portion Ta of the tire T without adding any modification to the wheel W. The first embodiment is therefore applicable to the ordinary tires. The first embodiment is realizable at a low cost.

(3) Using the ultrasonic sensor 12 enables the control circuit 14 to accurately detect a shape change occurring at the side surface portion Ta of the tire T even in a situation where some of the mud, dust, or rainwater on the road surface P adheres to the side surface portion Ta of the tire T.

(4) The ultrasonic sensor 12 includes a plurality of receiving section 12b arrayed in a predetermined (matrix or two-dimensional) pattern on the substrate 12c. Therefore, the ultrasonic sensor 12 can measure a distance change occurring between one point of the side surface portion Ta of the tire T and the ultrasonic sensor 12. Furthermore, the ultrasonic sensor 12 can detect a three-dimensional shape change of the side surface portion Ta of the tire T. Thus, the ultrasonic sensor 12 can accurately detect the stress acting from the road surface P to the wheel W based on this three-dimensional shape change.

The required number of the receiving sections 12b corresponds to the resolution of the shape change detection value of the detection object (more specifically, the resolution of the stress acting from road surface P to the wheel W). A higher resolution can be obtained by increasing the total number of the receiving sections 12b. Furthermore, the spatial intervals of respective receiving sections 12b should be set to the distance shorter than the wavelength of ultrasonic waves transmitted from the transmitting section 12a. The spatial intervals of respective receiving sections 12b correspond to the resolution. Therefore, regarding the total number and spatial intervals of respective receiving sections 12b, it is preferable to experimentally obtain optimum values through a cut and try testing considering the required resolution.

(5) It is preferable to appropriately select the type of ultrasonic sensor 12 considering the resonance frequency of the ultrasonic sensor 12 and the frequency of ultrasonic waves transmitted to the detection object (i.e. the ultrasonic waves emitted from the transmitting section 12a). For example, the piezoelectric ultrasonic sensor is simple in structure and is capable of increasing the resonance frequency of the ultrasonic sensor itself. Thus, the piezoelectric ultrasonic sensor is preferably used to transmit the ultrasonic waves having higher frequencies.

(6) The ultrasonic sensors 12 shown in FIGS. 3A and 3B can be manufactured by using the silicon micro-machining technique. The transmitting section 12a and the receiving sections 12b can be integrated on the single (i.e. same) substrate 12c. Therefore, the entire body of ultrasonic sensor 12 can be downsized. The ultrasonic sensor 12 can be easily assembled or installed on the vehicle. Namely,

### Second Embodiment

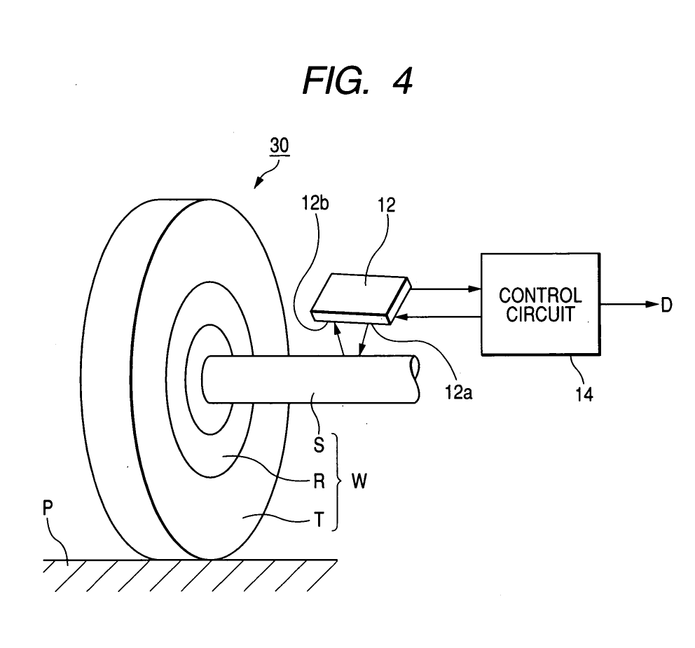

FIG. 4 is a perspective view explaining a schematic arrangement of a tire shape change detection apparatus 30 in accordance with a second embodiment of the present invention. The second embodiment is different from the first embodiment in that the transmitting section 12a and the receiving section 12b of the ultrasonic sensor 12 are disposed to face an outer circumferential surface of the axle S of the vehicle. The components identical with those already disclosed in the first embodiment will be denoted by the same reference numerals and will not be explained hereinafter.

More specifically, according to the second embodiment, the transmitting section 12a transmits ultrasonic waves toward an outer circumferential surface of the axle S. The receiving section 12b receives reflection sounds as ultrasonic waves reflected from the outer circumferential surface of the axle S. The receiving section 12b produces a detection signal which is sent to the control circuit 14. Then, based on both the drive signal and the detection signal, the control circuit 14 calculates or detects a shape change (i.e. deflection change) of the outer circumferential surface of the axle S based on the drive signal and the detection signal. Then, the control circuit 14 detects the stress (particularly, the lateral stress) acting from the road surface P to the wheel W based on the detection result of the shape change. Then, the control circuit 14 produces a data signal D representing the detected stress.

In general, when the stress acts on the wheel W from the road surface P, the outer circumferential surface of the axle S connected to the wheel W causes a shape change (i.e. deflection change). According to the second embodiment, the ultrasonic sensor 12 detects a shape change occurring on the outer circumferential surface of the axle S. Thus, the control circuit 14 of the second embodiment can accurately detect the stress acting from the road surface P to the wheel W. Accordingly, the second embodiment brings the functions and effects similar to those of the first embodiment.

The present invention is not limited to the first embodiment (which detects a shape change of the side surface portion Ta of the tire T located in the vicinity of the bottom of the tire T where tire T contacts with the road surface P) or to the second embodiment (which detects a shape change of the outer circumferential surface of the axle S). Thus, according to the present invention, the ultrasonic sensor 12 can detect a shape change of any other portion (such as an appropriate portion of the tire T or an appropriate portion of the rim R) which causes a significant amount of deformation in response to the stress acting from the road surface P to the wheel W.

### Other Embodiment

The present invention can be modified in the following manner.

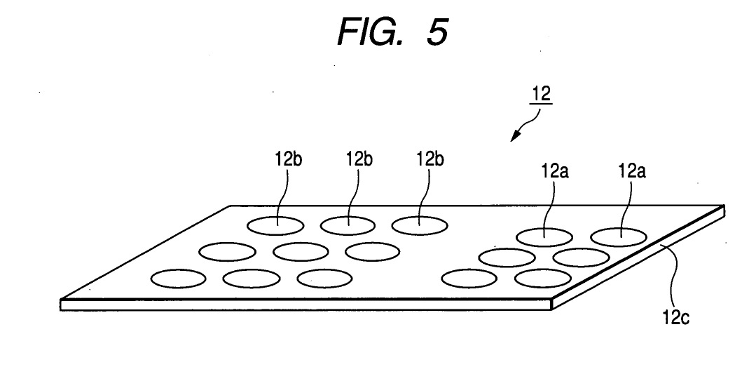

FIG. 5 is a perspective view showing a schematic arrangement of another ultrasonic sensor 12 in accordance with the present invention. The ultrasonic sensor 12 shown in FIG. 5 is different from the ultrasonic sensor 12 shown in FIG. 2 in that a plurality of (e.g. six according to the example shown in FIG. 5) transmitting sections 12a are arrayed in a predetermined (matrix or two-dimensional) pattern. The number of transmitting sections 12a corresponds to an acoustic output of the ultrasonic waves transmitted from the transmitting sections 12a. A larger acoustic output can be obtained by increasing the total number of the transmitting sections 12a. Furthermore, it is preferable to adequately determine the layout and arrangement of respective transmitting sections 12a to adjust the transmitting (emitting) direction of the ultrasonic waves. Therefore, regarding the total number and the layout of respective transmitting sections 12a, it is preferable to experimentally obtain optimum values through a cut and try testing considering the required acoustic output.

According to the ultrasonic sensors 12 shown in FIGS. 3A and 3B, the transmitting section 12a and the receiving sections 12b are integrated on the single (i.e. same) substrate 12c. It is however possible to use a predetermined number of conventional compact ultrasonic sensors to arrange these sections 12a and 12b.

It is possible to integrate only the receiving sections 12b on a single substrate, while the transmitting section 12a is separately arranged by using a conventional ultrasonic sensor. Alternatively, it is possible to integrate only the transmitting sections 12a on a single substrate, while the receiving section 12b is separately arranged by using a conventional ultrasonic sensor. In these cases, respective sections 12a and 12b can be placed with an appropriate distance between them as far as they can surely perform transmitting and receiving operations.

Furthermore, in a case that the vehicle is equipped with a back-sonar, this sonar can be used as the ultrasonic sensor 12 of the above-described embodiments. In this case, the back-sonar can measure the distance from the rear end of the vehicle to an obstacle and also can accurately detect the size and position of the detected obstacle. Accordingly, it becomes possible to realize an automatic parking assist system capable of accurately avoiding the collision of the vehicle.

As apparent from the foregoing description, the present invention provides a shape change detection apparatus including a transmitting means for transmitting a sensing medium (such as ultrasonic waves, millimeter waves, and infrared rays) to a detection object. The shape change detection apparatus further includes a receiving means for receiving a reflected sensing medium from the detection object after the sensing medium is transmitted from the transmitting means. The shape change detection apparatus further includes a shape change detecting means for detecting a shape change of the detection object based on the sensing medium transmitted from the transmitting means and the reflected sensing medium received by the receiving means. The receiving means of this invention includes a plurality of receiving sections each having the capability of receiving the reflected sensing medium, and these receiving sections are arrayed in a predetermined pattern.

1. A shape change detection apparatus comprising:
transmitting means for transmitting a sensing medium to a detection object;
receiving means for receiving a reflected sensing medium from said detection object after the sensing medium is transmitted from said transmitting means; and
shape change detecting means for detecting a shape change of said detection object based on the sensing medium transmitted from said transmitting means and the reflected sensing medium received by said receiving means, wherein
said receiving means comprises a plurality of receiving sections each having the capability of receiving the reflected sensing medium, and said plurality of receiving sections are arrayed in a predetermined pattern.

2. The shape change detection apparatus in accordance with claim 1, wherein said plurality of receiving sections arranging said receiving means and said transmitting means are mounted together on a single substrate.

3. The shape change detection apparatus comprising:
transmitting means for transmitting ultrasonic waves to a predetermined portion of a wheel of a vehicle;
receiving means for receiving reflection sounds as ultrasonic waves reflected from said wheel after the ultrasonic waves are transmitted from said transmitting means; and
shape change detecting means for detecting a shape change of said predetermined portion of said wheel based on the ultrasonic waves transmitted from said transmitting means and the ultrasonic waves received by said receiving means, wherein
said receiving means comprises a plurality of receiving sections each having the capability of receiving ultrasonic waves, and said plurality of receiving sections are arrayed in a predetermined pattern.

4. The shape change detection apparatus in accordance with claim 3, wherein said predetermined portion of said wheel is a side surface portion of said wheel located in the vicinity of a bottom of said wheel where said wheel contacts with a road surface.

5. The shape change detection apparatus in accordance with claim 3, wherein said predetermined portion of said wheel is an outer circumferential surface of an axle connected to said wheel.

6. The shape change detection apparatus in accordance with claim 3, wherein said predetermined portion of said wheel is an arbitrary portion of a rim of said wheel.

7. The shape change detection apparatus in accordance with claim 3, further comprising stress detecting means for detecting a stress acting from a road surface to said wheel based on the shape change of said predetermined portion of said wheel detected by said shape change detecting means.

8. The shape change detection apparatus in accordance with claim 3, wherein said plurality of receiving sections arranging said receiving means and said transmitting means are mounted together on a single substrate.
